(19) United States
(12) Patent Application Publication
(10) Pub. No.: US 2014/0040751 A1
(43) Pub. Date: Feb. 6, 2014

(54) DATA PROCESSING DEVICE, DATA PROCESSING METHOD, AND PROGRAM

(71) Applicant: PANASONIC CORPORATION, Osaka (JP)

(72) Inventors: Koichiro YAMAGUCHI, Osaka (JP); Hiroki SHINOHARA, Kyoto (JP); Ken-ichi SHIBATA, Osaka (JP)

(21) Appl. No.: 13/937,950

(22) Filed: Jul. 9, 2013

Related U.S. Application Data
(63) Continuation of application No. PCT/JP2013/000046, filed on Jan. 10, 2013.

(30) Foreign Application Priority Data
Aug. 3, 2012 (JP) 2012-172652

(51) Int. Cl. H04L 12/26

(52) U.S. Cl. CPC H04L 43/00
USPC 715/736

(57) ABSTRACT

Provided is a data processing device including: a selection unit which selects a server from among a plurality of servers; an acquisition unit which acquires messages from the plurality of servers; and a display unit which display a message acquired by the acquisition unit from the server selected by the selection unit, wherein the acquisition unit acquires, before acquiring a remaining message from the server, a message from a server which is next likely to be selected by the selection unit after the server.

### CROSS REFERENCE TO RELATED APPLICATIONS

This is a continuation application of PCT Patent Application No. PCT/JP2013/000046 filed on Jan. 10, 2013, designating the United States of America, which is based on and claims priority of Japanese Patent Application No. 2012-172652 filed on Aug. 3, 2012. The entire disclosures of the above-identified applications, including the specifications, drawings and claims are incorporated herein by reference in their entirety.

### FIELD

The present disclosure relates to a data processing device, a data processing method, and a program.

### BACKGROUND

PTL 1 discloses an example of storing a content item, which is to be presented first, into a memory that has less capacity but allows for fast read therefrom, and storing the other content items into a memory that has more capacity but does not allow for the fast read.

Moreover, PTL 2 discloses an example of checking a preferential activation flag included in the broadcast to preferentially acquire a content item, thereby minimizing the latency.

### CITATION LIST

### Patent Literature

[PTL 1] Japanese Unexamined Patent Application Publication No. 2002-320183
[PTL 2] Japanese Unexamined Patent Application Publication

### SUMMARY

### Technical Problem

The present disclosure provides a data processing device which can reduce the latency of message display.

### Solution to Problem

The data processing device according to the present disclosure includes a selection unit configured to select a server from among plural servers; an acquisition unit configured to acquire messages from the plural servers; and a display unit configured to display one or more messages acquired by the acquisition unit from the server selected by the selection unit, wherein the acquisition unit acquires a message from the server and, before acquiring a remaining message from the server, acquires a message from a server which is next likely to be selected by the selection unit after the server.

### Advantageous Effects

The data processing device according to the present disclosure is effective in reducing the latency of message display.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram of an overall system including a data processing device.

FIG. 2 is a hardware block diagram showing the primary hardware configuration of the data processing device.

FIG. 3 is a diagram showing a first example of a message listing screen displayed by the data processing device.

FIG. 4 is a diagram showing a second example of the message listing screen displayed by the data processing device.

FIG. 5 is a diagram showing a third example of the message listing screen displayed by the data processing device.

FIG. 6 is a diagram showing an example of a message screen displayed by the data processing device.

FIG. 7 is a diagram logically showing a first example of message switching on the message listing screen displayed by the data processing device.

FIG. 8 is a diagram showing a fourth example of the message listing screen displayed by the data processing device.

FIG. 9 is a diagram logically showing a second example of the message switching on the message listing screen displayed by the data processing device.

FIG. 10 is a diagram showing information on messages displayed by the data processing device.

FIG. 11 is a functional block diagram showing the primary functional block configuration of a data processing server.

FIG. 12 is a functional block diagram of a first example of the primary functional block configuration of the data processing device.

FIG. 13 is a flowchart illustrating an algorithm whereby the data processing device gets and displays a message.

FIG. 14 is a diagram showing an example of a gain status table of acquisition privilege and display privilege of current application which are held in the data processing device.

FIG. 15 is a flowchart illustrating an algorithm whereby the data processing device gets messages.

FIG. 16 is a flowchart illustrating an algorithm whereby the data processing device displays messages.

FIG. 17 is a flowchart illustrating an algorithm whereby the data processing device gets a message.

FIG. 18 is a diagram showing a fifth example of the message listing screen displayed by the data processing device.

FIG. 19 is a functional block diagram of a second example of the primary functional block configuration of the data processing device.

FIG. 20 is a functional block diagram of a third example of the primary functional block configuration of the data processing device.

### DESCRIPTION OF EMBODIMENT

Hereinafter, a non-limiting embodiment will be described in detail with reference to the accompanying drawings. However, unnecessarily detailed description may be omitted. For example, detailed description of well-known matters or description previously set forth with respect to components that are substantially the same may be omitted. This is to avoid unnecessarily redundancy in the description below and for facilitating an understanding by those skilled in the art.

It should be noted that the inventors provide the accompanying drawings and the description below for a thorough understanding of the present disclosure by those skilled in the art, and the accompanying drawings and the description are not intended to be limiting the subject matter recited in the claims appended hereto.

First, a problem to be solved by the present disclosure will be described in detail.

In recent years, with the growing popularity of digital devices, various pieces of information are delivered to user-owned digital devices. Some of such information takes a form in which an information provider sends a notification message to the digital device and forcibly display the notification message on the digital device. Furthermore, not only sending a notification message, the information provider can also hold the sent notification message at a server of the information provider, so that the user can later read the sent notification message. However, a large amount of messages may be transmitted. Thus, if the message acquisition method or the display method is not devised, latency occurs when the user later reads the message, ending up reducing the user convenience. For example, if all messages are collectively acquired, disadvantage occurs in which no message is displayable until the acquisition of all the messages.

PTL 1 discloses an example of storing a content item, which is to be presented first, into a memory that has less capacity but allows for fast read therefrom, and storing the other content items into a memory that has more capacity but does not allow for the fast read. According to the technique disclosed in PTL 1, the acquired content can be stored in a manner that the latency of display is reduced.

Moreover, PTL 2 discloses an example of checking the preferential activation flag included in the broadcast to preferentially get a content item, thereby minimizing the latency. According to the technique disclosed in PTL 2, by analyzing the preferential activation flag explicitly indicated in a content item the content item is preferentially acquired, thereby reducing the latency.

PTL 1, however, fails to disclose a method for acquiring the content. Moreover, PTL 2 is unusable unless the preferential activation flag is indicated in a content item.

The present disclosure provides a data processing device which can reduce the latency of message display.

The data processing device according to the present disclosure includes a selection unit configured to select a server from among plural servers; an acquisition unit configured to acquire messages from the plural servers; and a display unit configured to display one or more messages acquired by the acquisition unit from the server selected by the selection unit, wherein the acquisition unit acquires a message from the server and, before acquiring a remaining message from the server, acquires a message from a server which is next likely to be selected by the selection unit after the server.

According to the above configuration, in the state where the data processing device is displaying messages, a message which is next likely to be read by the user can be acquired (prefetched) before the user performs the operation. Thereafter, when the user selects a message desired by the user to read next is selected, the message desired by the user to read next is already acquired in the data processing device by the prefetch. Thus, the data processing device can display a message desired by a user to read next instantly after the user selects the message. Thus, the latency of the message display can be reduced.

The messages are information delivered from a service provider to a user, according to various services. For example, the messages are information for a service provider, which allows the user to view content, to notify the user that new content is available for the user to view. Also, for example, the messages are information for a service provider, which assists user communication, to notify the user of information on a person close to the user.

Moreover, for example, the display unit and displays pieces of information indicating the plural servers which have included the messages acquired by the acquisition unit, the pieces of information being arranged, and the acquisition unit acquires, before acquiring the remaining message from the server, a message from a server, among the plural servers, that is subsequent to the server in arrangement order on the display unit.

According to the arrangement order on the display unit, a message next likely to be read by the user can be acquired (prefetched) before the user performs the operation. Thus, the latency of the message display can be reduced.

In particular, the present disclosure has a great effect for a device (for example, a TV operated by a remote controller having up, down, left, and right keys) which has an interface through which the message selection state transitions by user operation from the message currently being read to a message desired by the user to read next, thereby selecting the message desired by the user to read next.

Moreover, for example, the selection unit selects a first server, which is the server selected by the selection unit, according an instruction from a user, the acquisition unit acquires at least one first message which is the one or more messages from the first server, and the acquisition unit further acquires a second message which is a message from a second server which is one of the plural servers and subsequent to the first server in the arrangement order on the display unit, and acquire, as a remaining message, at least one third message different from the at least one first message from the first server, in a period in which the display unit displays the at least one first message.

According to the above configuration, a message which is next likely to be read by the user can be acquired (prefetched) before the user performs the operation in a state where the first message of the first server is in the selected state. The message which is next likely to be read by the user is, specifically, one (the second message) of the messages from the second server, and a message (the third message) from the first server other than the first message.

When the user thereafter selects a message desired by the user to read next, the message desired by the user to read next is already acquired by the prefetch into the data processing device. Thus, when the user selects the message desired by the user to read next, the data processing device can immediately display the message. Thus, the latency of the message display can be reduced.

Moreover, for example, the acquisition unit acquires, as the at least one first message, a new message which has not been acquired by the acquisition unit among messages included in the first server.

According to the above configuration, a message which has not been read by the user is acquired as the first message. The user can efficiently read the message unread by the user.

Moreover, for example, the acquisition unit acquires, as the at least one third message, a remaining message included in the first server except for the at least one first message.

According to the above configuration, a message stored in the first server other than the first message is acquired as the third message. The data processing device acquires all the messages that are in the first server. In particular, the latency of the message display can be reduced when the user wishes to read messages in the first server one after another.

Moreover, for example, after acquiring the at least one third message, the acquisition unit acquires a fourth message from a third server which is one of the plural servers and subsequent to the second server in the arrangement order on the display unit, and acquires at least one message different from the second message from the second server.

According to the above configuration, a message is acquired in the same manner also from a third server from which the user is next likely to read messages to the second server. The latency of the message display can be reduced, in particular, when the user wishes to read messages from different servers one after another.

Moreover, for example, after acquiring the at least one third message, the acquisition unit acquires a message from a fourth server which is one of the plural servers and preceding the first server in the arrangement order on the display unit.

According to the above configuration, a message is acquired in the same manner also from a fourth server from which the user is next likely to read messages as well as the second server. The latency of the message display can be reduced, in particular, when the user wishes to check a previous message again while reading messages from different servers one after another.

Moreover, for example, the data processing device further including: a holding unit including a memory and configured to hold the messages acquired by the acquisition unit, wherein when the acquisition unit acquires a new message, the holding unit stores the new message in the memory, and preferentially deletes, from the memory, a message, among the messages displayed on the display unit, that is displayed at a position most distant from a position at which information, among the pieces of information, which indicates the server selected by the selection unit is displayed.

According to the above configuration, a message acquired from a server can be held in the data processing device. If a new message is held and exceeds the storage capacity within the data processing device, a message is deleted starting with a message displayed most distant from a server or a message (the message being read by the user) that is selected on the display unit. The message displayed more distant from where the cursor is displayed on the display unit is relatively less likely to be read next by the user. Thus, by doing this, the latency of the message display can be reduced.

Moreover, for example, the display unit further displays a cursor at a position where information, among the pieces of information, is displayed which indicates the server selected by the selection unit.

According to the above configuration, the cursor displayed on the display unit allows the user to visually understand the selected server or the selected message.

Moreover, the data processing method according to one aspect of the present disclosure includes (a) selecting a server from among plural servers; (b) acquiring messages from the plural servers; and (c) displaying one or more messages acquired in step (b) from the server selected in step (a), wherein in step (b), a message is acquired from the server and, before acquiring a remaining message from the server, a message is acquired from a server which is next likely to be selected in step (a) after the server.

According to the above configuration, the same advantageous effects as obtained by the above data processing device are achieved.

Moreover, a storage medium according to one aspect of the present disclosure is a non-transitory computer-readable storage medium having stored therein a program for causing a computer to execute the data processing method described above.

According to the above configuration, the same advantageous effects as obtained by the above data processing device are achieved.

### EMBODIMENT

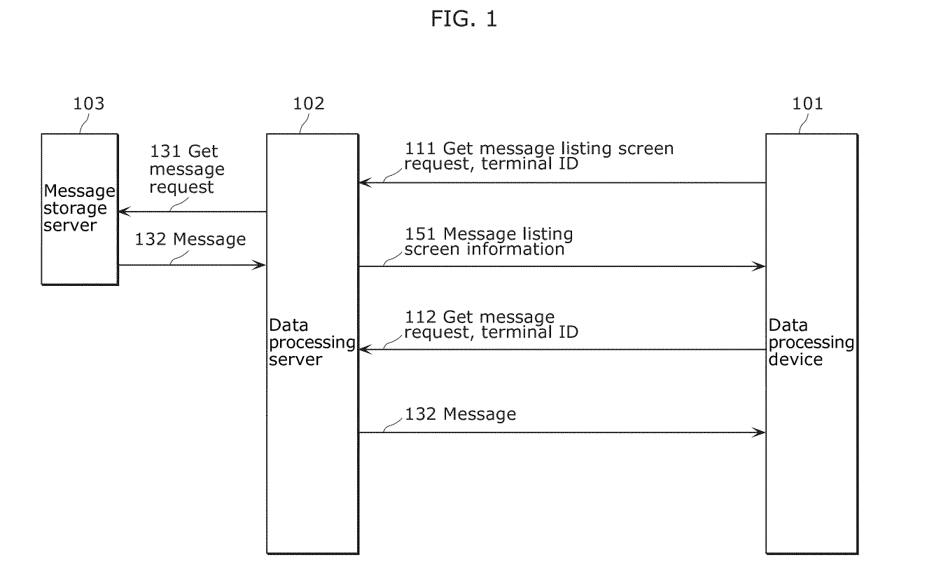

Hereinafter, a non-limiting embodiment 1 will be described, with reference to FIGS. 1 to 20.

[1-1. Configuration]

FIG. 1 is a block diagram of an overall system including a data processing device according to the embodiment 1. The system shown in FIG. 1 includes a data processing device 101, a data processing server 102, and a message storage server 103. It should be noted that the message storage server may be simply referred to as a server.

The data processing device 101 makes a get message listing screen request 111 to the data processing server 102. Upon the get message listing screen request 111, the data processing device 101 also transmits a terminal ID as well which is information whereby the own device is identifiable. Since the get message listing screen request 111 transmits the terminal ID, a secure communication scheme may be employed to prevent spoofing or the like.

Once received the get message listing screen request 111 from the data processing device 101, the data processing server 102 transmits a message listing screen information 151 corresponding to the data processing device 101, to the data processing device 101.

The data processing device 101 transmits, to the data processing server 102, a get message request 112 with respect to one or more messages described in the message listing screen information 151. When transmitting the get message request 112, the terminal ID which is information whereby the own device is identifiable is also transmitted as well. Since the get message request 112 transmits the terminal ID, a secure communication scheme may be employed to prevent spoofing or the like. It should be noted that the data processing device 101 may be incorporated in the data processing server 102. In this case, a device which displays messages may separately be prepared.

Once received the get message request 112 from the data processing device 101, the data processing server 102 makes a get message request 131 to the message storage server 103 storing the appropriate message.

The message storage server 103 is a server storing messages. Once received the get message request 131 from the data processing server 102, the message storage server 103 transmits a message 132 corresponding to the get message request 131, to the data processing server 102.

The data processing server 102 transmits the message 132 received from the message storage server 103 to the data processing device 101.

It should be noted that the message storage server 103 may be a plurality of servers storing different messages. In that case, the data processing server 102 holds the correspondence between a message and a message storage server, so that the storage location of messages is identifiable. Alternatively, the message storage server 103 may be incorporated in a form of a hard disk in the data processing server 102.

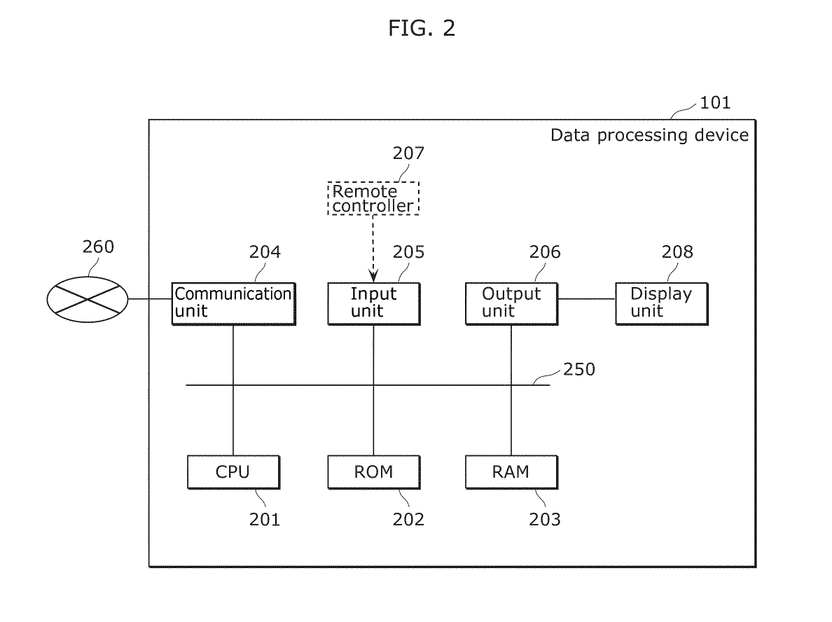

FIG. 2 is a hardware block diagram showing the primary hardware configuration of the data processing device 101.

The data processing device 101 includes a central processing unit (CPU) 201, a read only memory (ROM) 202, a random access memory (RAM) 203, a communication unit 204, an input unit 205, an output unit 206, and a bus line 250.

The CPU 201 is connected to the bus line 250. The CPU 201 executes a program stored in the ROM 202 or the RAM 203 to control the ROM 202, the RAM 203, the communication unit 204, the input unit 205, and the output unit 206, thereby implementing various functions. For example, the CPU 201 implements the functionality of decoding a communication message acquired from a communication network 260 and outputting the decoded message to a display unit 208.

The ROM 202 is connected to the bus line 250. The ROM 202 stores a program that defines the operation of the CPU 201, and data to be utilized by the CPU 201.

The RAM 203 is connected to the bus line 250. The RAM 203 temporarily stores data that occurs with the CPU 201 executing the program. Moreover, the RAM 203 temporarily stores data received or to be transmitted by the communication unit 204.

The output unit 206 is connected to the bus line 250 and the display unit 208. The output unit 206 is controlled by the CPU 201 and outputs data for displaying a text or an image on the display unit 208.

The input unit 205 is connected to the bus line 250. The input unit 205 is controlled by the CPU 201, and has the functionality of receiving operational commands from a user which are wirelessly transmitted from a remote controller 207, and transmitting the received operational commands to the CPU 201. It should be noted that, not limiting to the operational commands from the remote controller 207, the input unit 205 may receive operational commands by a tapping action using a mouse or a finger (including an object operated by the user).

The communication unit 204 is connected to the bus line 250 and the communication network 260. The communication unit 204 is controlled by the CPU 201, and has the functionality of transmitting/receiving data to/from external communication equipment via the communication network 260.

Here, the communication network 260 is implemented in optical communication line, a telephone line, or radio link, and connected to external communication equipment, the Internet, or the like.

The data processing device 101 implemented in the above-described hardware implements various functions by the CPU 201 executing a program stored in the ROM 202 or the RAM 203 and controlling the ROM 202, the RAM 203, the communication unit 204, the input unit 205, and the output unit 206.

Hereinafter, the functional configuration of the data processing device 101 will be described with reference to the accompanying drawings.

<Functional Configuration of Data Processing Device>

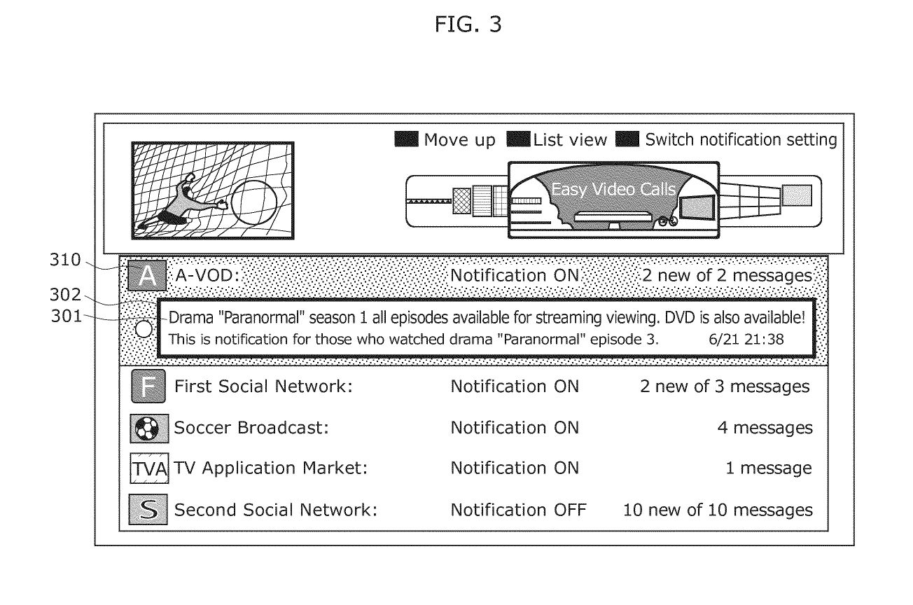

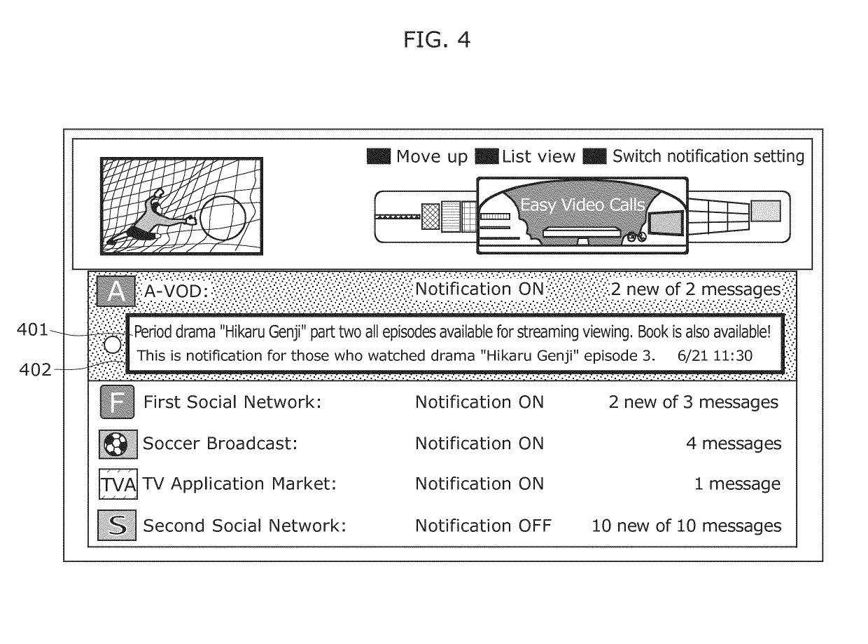

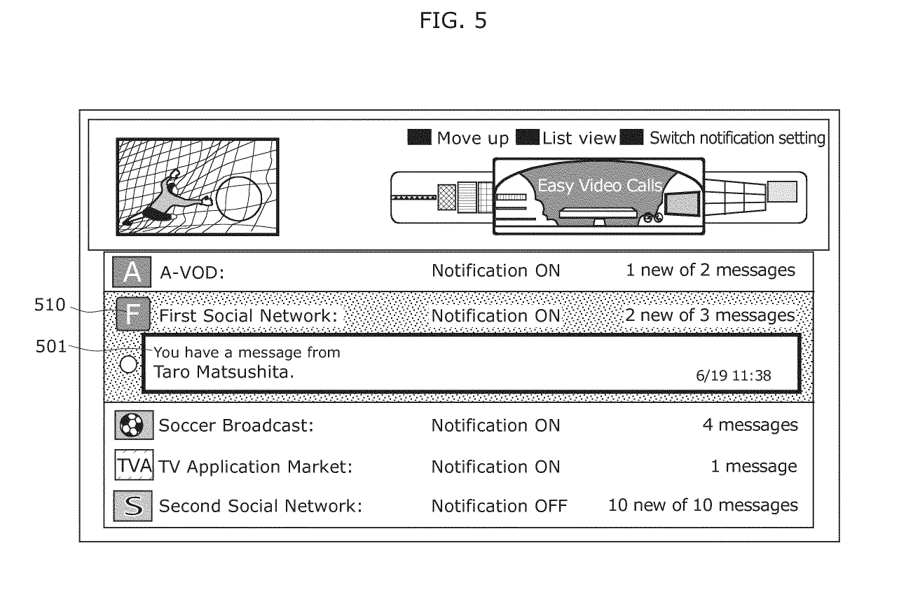

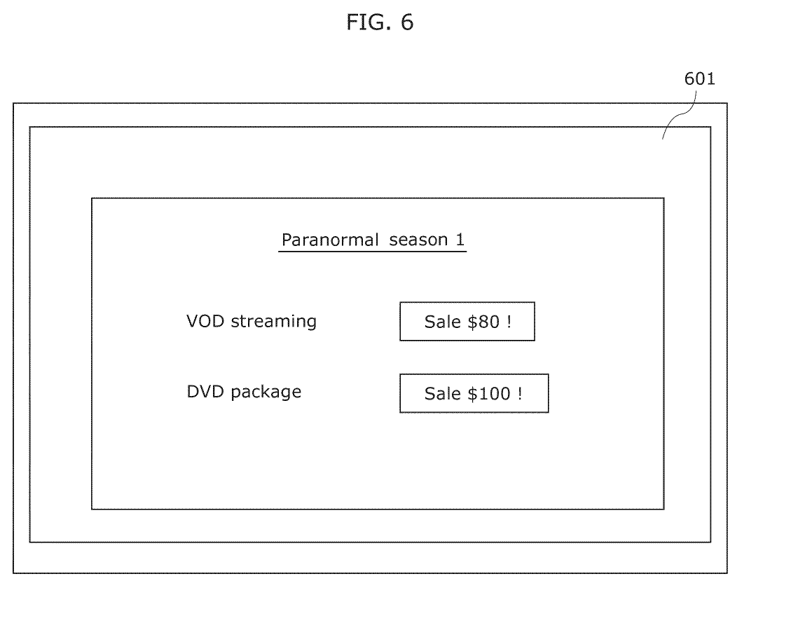

FIG. 3, FIG. 4, and FIG. 5 are diagrams showing examples of the message listing screens displayed by the data processing device. FIG. 6 shows an example of a message screen displayed by the data processing device. Messages are organized for each service provider providing the messages.

FIG. 3 is a diagram showing a first example of the message listing screen displayed by the data processing device.

FIG. 3 shows an example of the initial display of the message listing screen. An image 310 is for representing a service provider, and different for each service provider. Displayed immediately below the image 310 is a message 301 from the service provider. It should be noted that the message 301 may not be displayed immediately below the image 310, and may be laid out, so that the correspondence between the service provider and the message is identifiable. In the present embodiment, a plurality of images representing service providers is displayed and one message is displayed. Such display can specify a message currently being viewed by the user, and eliminate the inconvenience in which a large number of messages are displayed. If unread message which is a message unread by the user is displayed as the message 301 is displayed, the inconvenience is further eliminated. Then, the message 301 is indicated by a focus (cursor) 302 which receives remote controller operation. The user can use the remote controller operation to switch messages, starting from the message 301 indicated by the focus 302. Here, while a cursor is displayed by way of example as a focus which receives the remote controller operation, the focus is not limited to cursor. The focus may be any that can convey to the user a position at which the remote controller operation is received on the message screen.

FIG. 4 is a diagram showing a second example of the message listing screen displayed by the data processing device.

FIG. 4 shows message switching using the remote controller operation, by way of example. Once the user depresses either the left or right key of the remote controller, a message switches to another message 401 from the same service provider. According to the display switching, a focus 402 indicates the other message 401. It should be noted that the message switching may be performed by depressing another key, not limited to either the left or right key of the remote controller. When unread message is preferentially displayed by switching the messages one by one using the remote controller operation, the inconvenience to the user is eliminated.

FIG. 5 is a diagram showing a third example of the message listing screen displayed by the data processing device.

FIG. 5 shows service provider switching using the remote controller operation, by way of example. Once the user depresses either the up or down key of the remote controller, a message switches to a message 501 from another service provider. The message 501 is displayed immediately below an image 510 from the other service provider, so that it is known that the display has changed to the message from the other service provider. According to the display switching, a focus 502 indicates the message 501. It should be noted that the service provider switching may be performed by depressing another key, not limited to either the up or down key of the remote controller.

FIG. 6 is a diagram showing an example of a message screen displayed by the data processing device.

FIG. 6 shows an example of the message screen when a message is selected by the remote controller operation. When a determination key of the remote controller is depressed while the message is being indicated by the focus, the message screen transitions to a message screen 601 showing services corresponding to the message. For example, if the selected message is an advertizing message for a drama, it is conceivable that the message screen transitions to a message screen showing a VOD streaming and detailed sales information of the DVD package of the drama. It should be noted that the message selection may be made by depressing another key, not limited to the determination key of the remote controller.

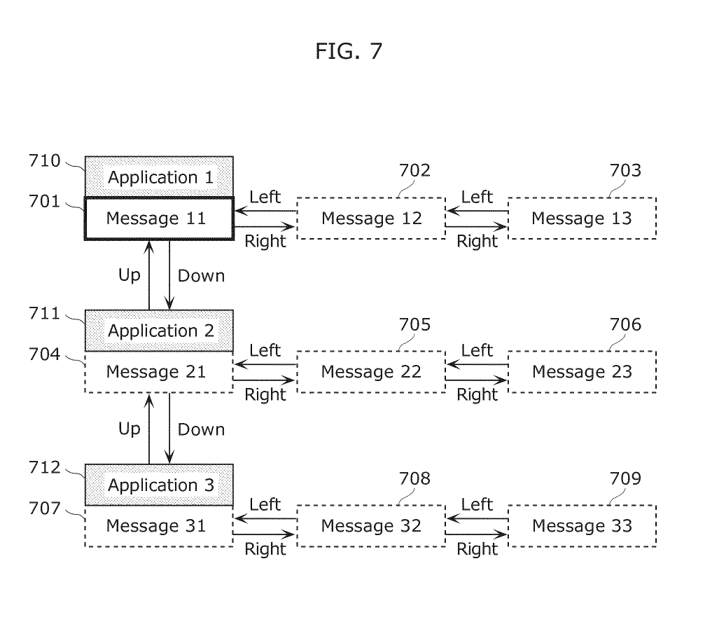

FIG. 7 is a diagram logically showing a first example of the message switching on the message listing screen displayed by the data processing device.

FIG. 7 is, specifically, a diagram logically showing the message display switching and the service provider switching on the message listing screen shown in FIG. 3, FIG. 4, and FIG. 5 which are displayed by the data processing device 101. It should be noted that, hereinafter, a service provided by a service provider will be referred to as application. Starting from a message 701 which is initially displayed, the message display is switched by either the left or right key of the remote controller, and application is switched by either the up or down key. Messages 702, 703, 704, 705, 706, 707, 708, and 709 are, while not initially displayed, displayed by the remote controller operation. Application is switched in a manner that a message belonging to the application switched to is identifiable. For example, the message 704 is displayed immediately below an image 711 representing the application switched to. It should be noted that, while not shown, for the message 702 or 703 also, the up and down key may be used to switch application as with the message 701. For example, by depressing the down key on the message 702, the message is switched to the message 704, and by depressing the up key in the message 704, the message is switched to the message 702. At the time, if a message from which the application switching is made (the message before the switching is made, the message 702 in the present example) is memorized, the message from which the switching is made can be restored after the message switching.

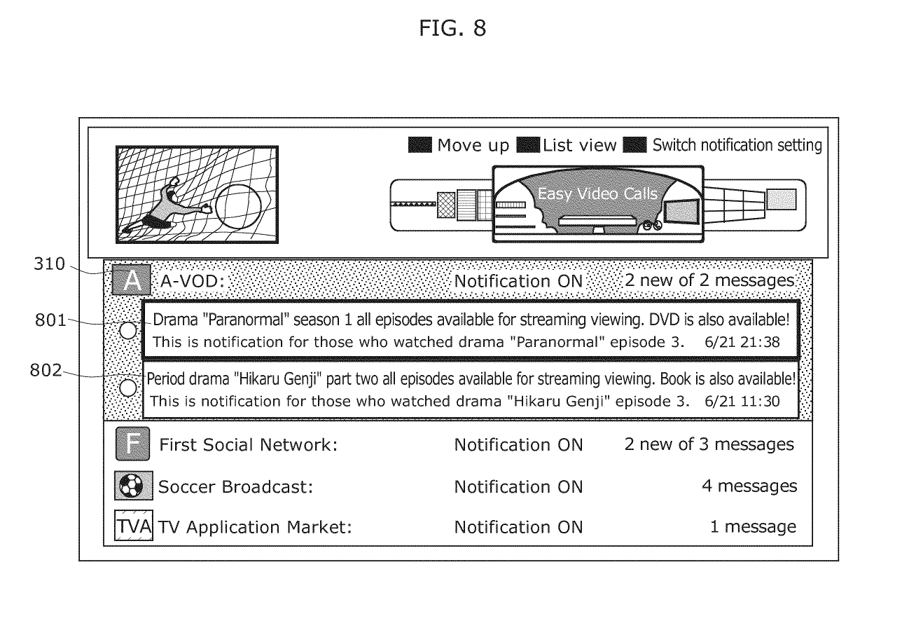

FIG. 8 is a diagram showing a fourth example of the message listing screen displayed by the data processing device.

FIG. 8 shows, specifically, another example of the initial display of the message listing screen, and is a diagram showing an example in which two messages 801 and 802 are initially displayed for one application.

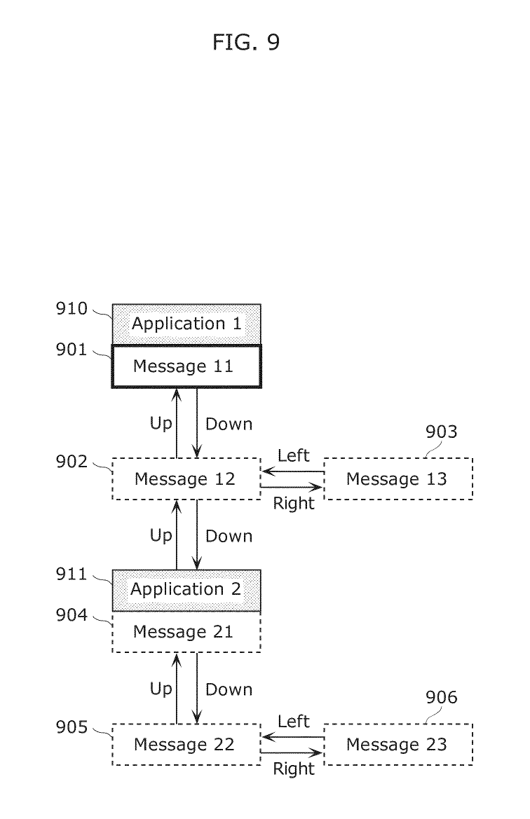

FIG. 9 is a diagram logically showing a second example of the message display switching on the message listing screen displayed by the data processing device.

FIG. 9 is, specifically, a diagram logically showing the message display switching and the service provider switching on the message listing screen which is shown in FIG. 8 and displayed by the data processing device 101. Starting from a message 901 which is initially displayed, the message display is switched by either the left or right key of the remote controller, and the message display or application is switched by either the up or down key. Messages 903, 904, 905, and 906 are, while not initially displayed, displayed by the remote controller operation. Application is switched in a manner that it is identifiable that the message belonging to the application switched to is being displayed. For example, the message 904 and the message 905 are displayed immediately below an image 911 representing the application switched to.

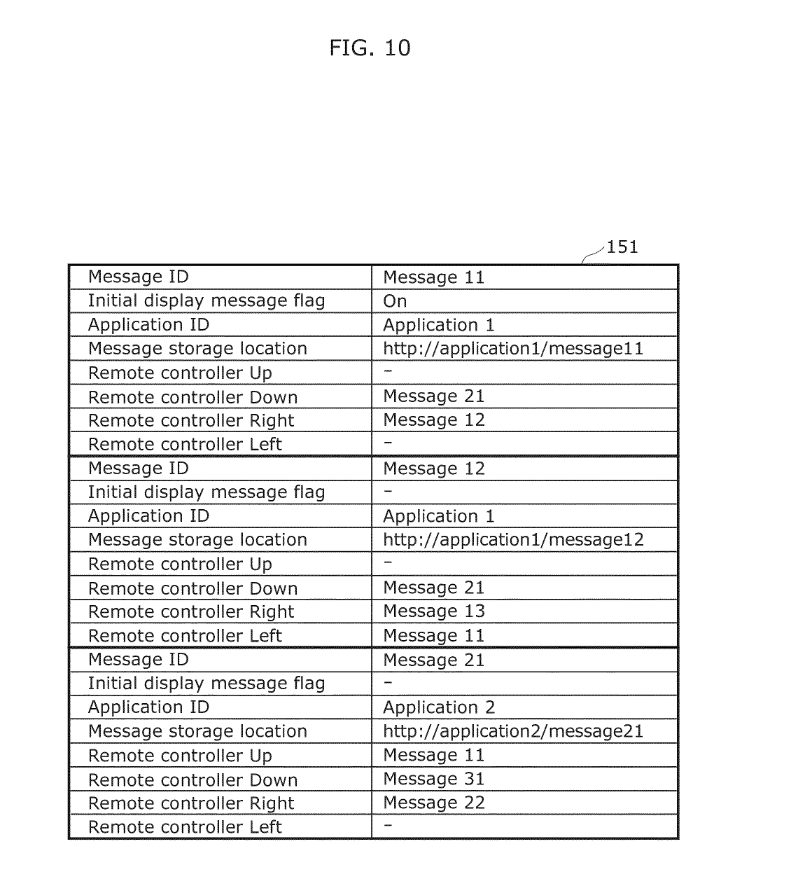

FIG. 10 shows an example of the message listing screen information 151 corresponding to FIG. 7. The message listing screen information 151 defines information included in a message. Each message is identified by a message ID in the message listing screen information 151. The information on the message includes “Initial display message flag” representing whether the message is to be initially displayed, “Application ID” representing application to which the message belongs, “Message storage location” representing the storage location of the message, and “remote controller direction” (the remote controller direction is assigned with remote controller key names such as up, bottom, right, and left) representing a next message to which the focus is to indicate upon reception of the remote controller operation while a message is being indicated by the focus. Based on the information, the data processing device 101 can determine disposition of messages, initial focus, and focus transition by the remote controller.

It should be noted that the message listing screen information 151 may include coordinate information, date information, and the like which are disposed on the screen, in addition to the above information.

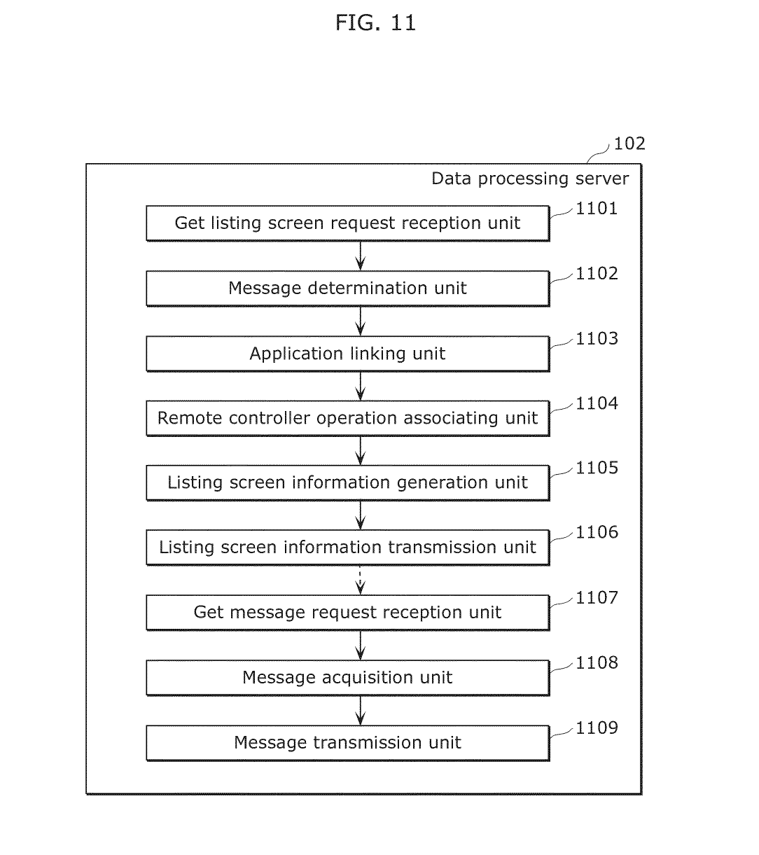

FIG. 11 is a functional block diagram showing the primary functional block configuration of the data processing server 102.

A get listing screen request reception unit 1101 receives the get message listing screen request and the terminal ID transmitted from the data processing device 101, and passes the get message listing screen request and the terminal ID to a message determination unit 1102.

The message determination unit 1102 determines messages to be transmitted to the data processing device 101, and passes the messages to an application linking unit 1103. Examples of the messages include mail and push messages which are transmitted to the data processing device 101.

The application linking unit 1103 determines application to which the message belongs, links the application ID to the message, and passes the linked application ID and the linked message to a remote controller operation associating unit 1104.

The remote controller operation associating unit 1104 determines content of the remote controller operation for a message, and passes the content of the remote controller operation to a listing screen information generation unit 1105. The content of the remote controller operation is, for example, ID of a message to which the focus transitions when the down key of the remote controller is depressed while the focus is indicating a message.

The listing screen information generation unit 1105 describes, as message listing screen information for all the messages determined by the message determination unit 1102, message information which is linked by the application linking unit 1103 and the remote controller operation associating unit 1104, and passes the message listing screen information to a listing screen information transmission unit 1106.

The listing screen information transmission unit 1106 transmits the message listing screen information to the data processing device 101.

A get message request reception unit 1107 receives the get message request 112 and the terminal ID transmitted from the data processing device 101, and passes the get message request 112 and the terminal ID to a message acquisition unit 1108.

The message acquisition unit 1108 acquires a message from the message storage server 103, based on the message storage location of the message information, and passes the message to a message transmission unit 1109.

The message transmission unit 1109 transmits the message to the data processing device 101.

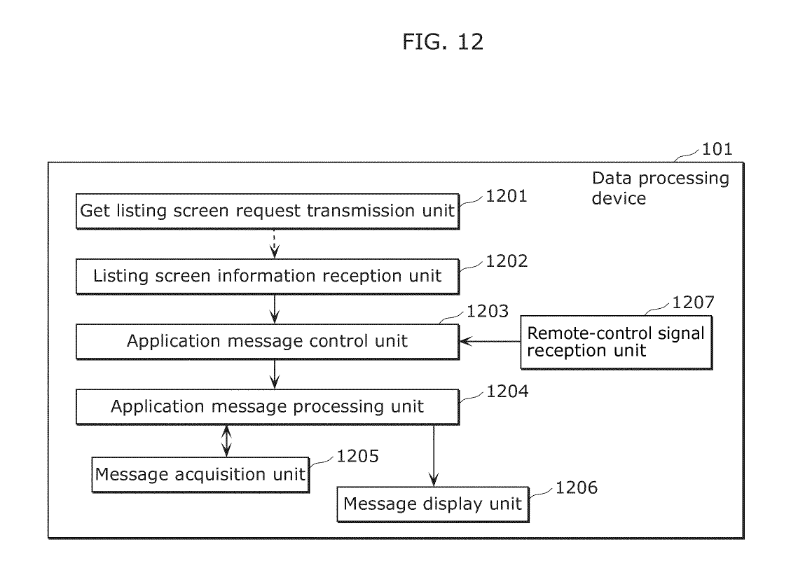

FIG. 12 is a functional block diagram of a first example of the primary functional block configuration of the data processing device 101.

A get listing screen request transmission unit 1201 transmits the get message listing screen request and a terminal ID to the data processing server 102.

A listing screen information reception unit 1202 receives the message listing screen information transmitted from the data processing server 102, and passes the received message listing screen information to an application message control unit 1203.

A remote-control signal reception unit 1207 receives a remote-control signal, and passes the received remote-control signal to the application message control unit 1203.

The application message control unit 1203 controls the operation of an application message processing unit 1204, such as, acquisition and display of messages. Moreover, the application message control unit 1203 controls the application message processing unit 1204, based on the remote-control signal passed from the remote-control signal reception unit 1207.

The same number of application message processing units 1204 as the applications are prepared and the application message processing units 1204 each perform message processing of the appropriate application for each application, pass a message acquisition instruction to a message acquisition unit 1205, and pass a message display instruction to a message display unit 1206.

Once received, from the application message processing unit 1204, the instruction for message acquisition, the message acquisition unit 1205 acquires a message from the data processing server 102, and passes the message to the application message processing unit 1204.

The message display unit 1206 externally displays, via the display unit 208, a message for which the instruction for the image display is received from the application message processing unit 1204.

[1-2. Operation]

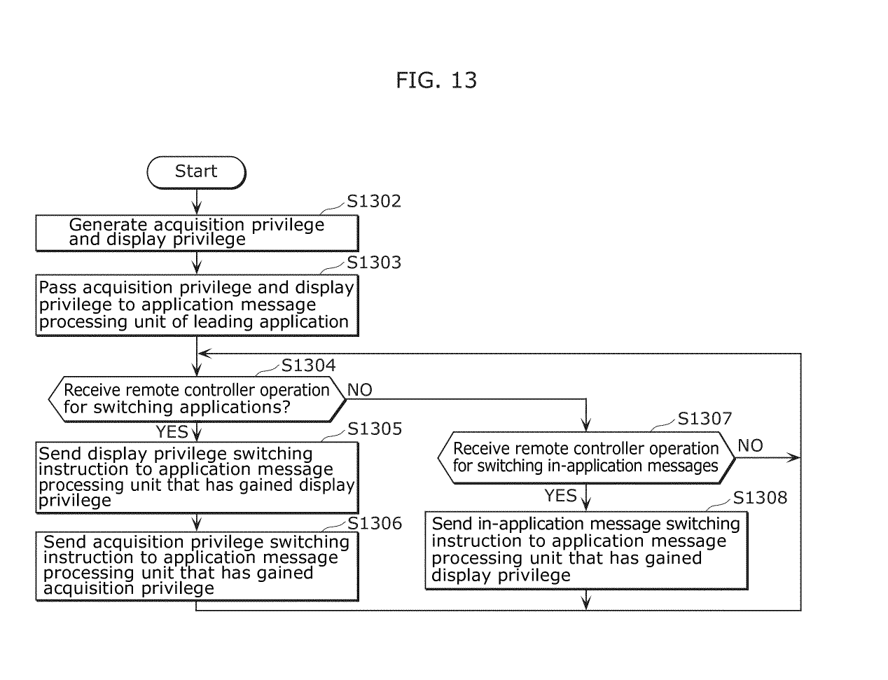

FIG. 13 is a flowchart illustrating an algorithm used by the application message control unit 1203 of the data processing device 101. The application message processing unit 1204 operates as one process per application. In other words, if there is a plurality of applications, the same number of application message processing units 1204 as the applications operate.

In step S1302, the application message control unit 1203 generates an acquisition privilege to acquire messages, and a display privilege to display messages. The acquisition privilege is a privilege for the application message processing unit 1204 to control the order of acquiring messages, and is managed in a manner being held (also expressed as “gained”) by any of the same number of application message processing units 1204 as the applications. Only the application message processing unit 1204 that has gained the acquisition privilege can acquire messages from servers. The display privilege is a privilege for the application message processing unit 1204 to control the order of displaying messages, and is, as with the acquisition privilege, managed in a manner being held by any of the same number of application message processing units 1204 as the applications. Only the application message processing unit 1204 that has gained the display privilege can display messages. There are one display privilege and one acquisition privilege.

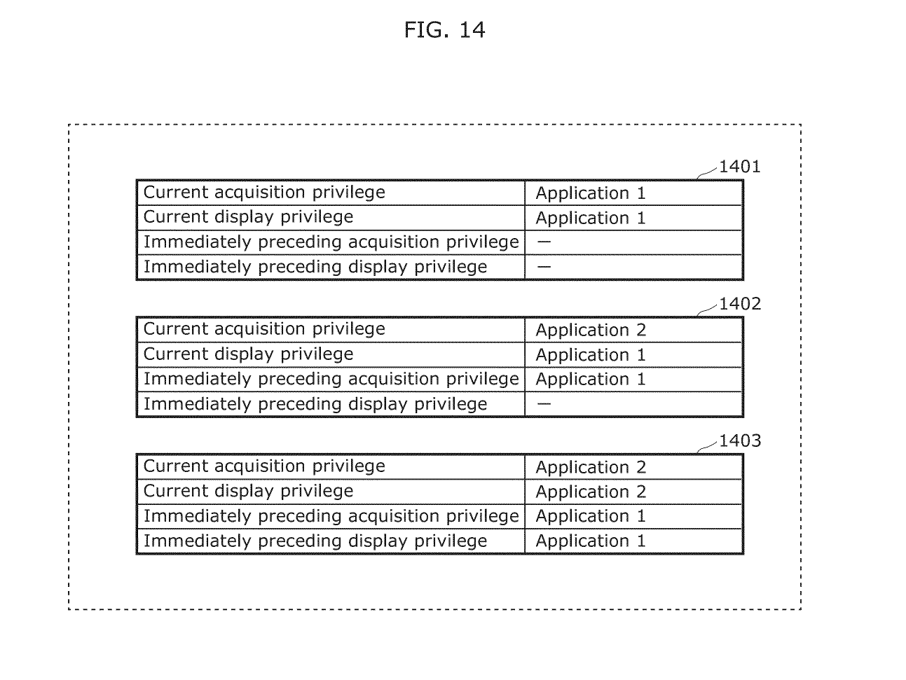

In step S1303, the application message control unit 1203 passes the acquisition privilege and the display privilege to the application message processing unit 1204 of an application (leading application) of a message flagged as the initial display message in the message listing screen information. Moreover, the application message control unit 1203 describes the ID of the leading application in a field “Current acquisition privilege” or “Current display privilege” in a gain status table (a privilege gain status table) of the acquisition privilege and the display privilege as shown in FIG. 14. The privilege gain status table at which point is as shown in a gain status table 1401. An application 1 has gained the acquisition privilege and the display privilege, and an immediately preceding acquisition privilege and an immediately preceding display privilege are gained by none (-).

In step S1304, the application message control unit 1203 determines whether the remote-control signal received by the remote-control signal reception unit 1207 is remote controller operation for switching applications.

If NO in step S1304, the application message control unit 1203 determines whether the remote-control signal is remote controller operation for switching in-application messages in step S1307.

If NO in step S1307, the application message control unit 1203 repeats step S1304, waiting for the remote-control signal to be received again by the remote-control signal reception unit 1207.

If YES in step S1304, the application message control unit 1203 sends, in step S1305, a display privilege switching instruction that conveys an application to be switched to, to the application message processing unit 1204 that has gained the display privilege, based on the privilege gain status table. Furthermore, in step S1306, the application message control unit 1203 sends an acquisition privilege switching instruction that conveys an application to be switched to, to the application message processing unit 1204 that has gained the acquisition privilege. Then, the application message control unit 1203 repeats step S1304, waiting for the remote-control signal to be received again by the remote-control signal reception unit 1207.

If YES in step S1307, the application message control unit 1203 sends, in step S1308, an in-application message switching instruction to the application message processing unit 1204 that has gained the display privilege. Then, the application message control unit 1203 repeats step S1304, waiting for the remote-control signal to be received again by the remote-control signal reception unit 1207.

FIG. 14 shows an example of the gain status table (the privilege gain status table) of the acquisition privilege and the display privilege, generated by the application message control unit 1203, of the application message processing unit 1204.

The gain status table 1401 is in its initial state. The table 1401 represents a status in which the application message processing unit 1204 processing the application 1 has gained the acquisition privilege and the display privilege. A gain status table 1402 represents a status in which the acquisition privilege has been transferred from as shown in the status of the gain status table 1401 to the application message processing unit 1204 processing an application 2.

A gain status table 1403 represents a status in which the display privilege has been transferred from as shown in the status of the gain status table 1402 to the application message processing unit 1204 processing the application 2.

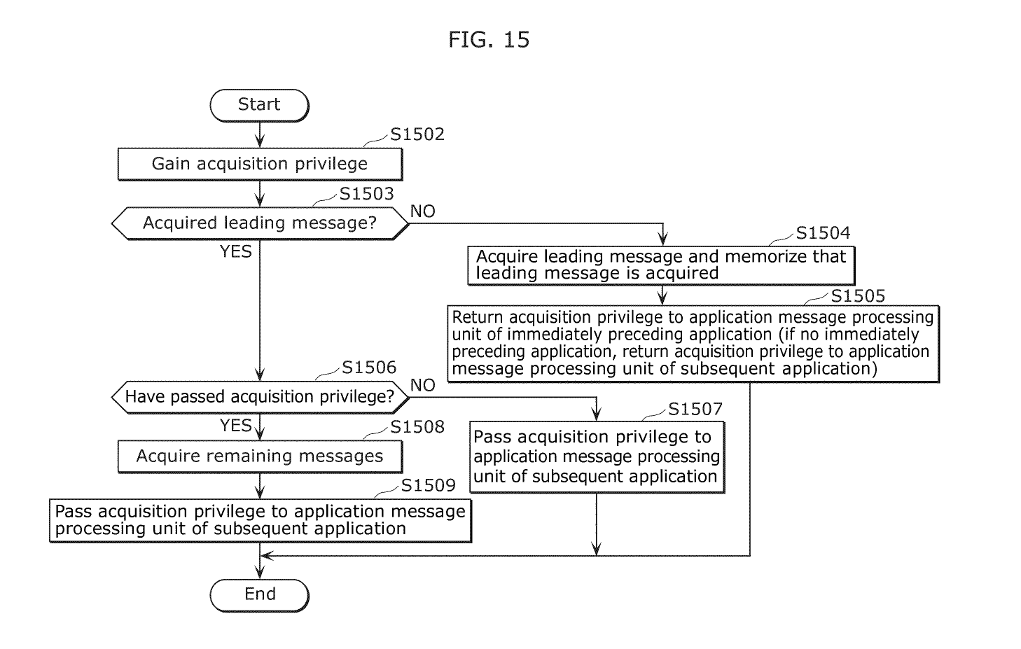

FIG. 15 is a flowchart illustrating an algorithm whereby the application message processing unit 1204 acquires a message in the data processing device 101.

In step S1502, the application message processing unit 1204 gains the acquisition privilege to acquire messages, from the application message control unit 1203 or another application message processing unit 1204. Once gained the acquisition privilege, the application message processing unit 1204 starts processing of the next step S1503.

In step S1503, the application message processing unit 1204 determines whether the application message processing unit 1204 has acquired the leading message of the application. This determination is implemented by memorizing that the leading message is acquired in step S1504 described below. The leading message is a message to be initially displayed in the application, and may be, for example, the message earliest in date (the oldest message).

If NO in step S1503, the application message processing unit 1204 acquires the leading message and memorizes that the application message processing unit 1204 has acquired the leading message in step S1504.

In step S1505, the application message processing unit 1204 of the current application returns the acquisition privilege to the application message processing unit 1204 of the immediately preceding application. The immediately preceding application can be known by looking at the privilege gain status table. After returning the acquisition privilege to the application message processing unit 1204 of the immediately preceding application, the application message processing unit 1204 of the current application rewrites “Current acquisition privilege” in the gain status table by the ID of the immediately preceding application, and rewrites “Immediately preceding acquisition privilege” by the ID of the own application. If there is no immediately preceding application, the application message processing unit 1204 passes the acquisition privilege to the application message processing unit 1204 of the subsequent application. Then, the application message processing unit 1204 of the current application rewrites “Current acquisition privilege” in the gain status table by an ID of the subsequent application, and rewrites “Immediately preceding acquisition privilege” by the ID of the own application.

If YES in step S1503, the application message processing unit 1204 determines whether the application message processing unit 1204 has passed the acquisition privilege in step S1506.

If NO in step S1506, the application message processing unit 1204 passes the acquisition privilege to the application message processing unit 1204 of the subsequent application in step S1507. The subsequent application indicates an application switched to when the application switching occurs from the remote controller operation content defined in the message listing screen information 151. After passed the acquisition privilege, the application message processing unit 1204 of the current application rewrites “Current acquisition privilege” in the privilege gain status table by the ID of the subsequent application, and rewrites “Immediately preceding acquisition privilege” by the ID of the own application. Moreover, the application message processing unit 1204 memorizes that the application message processing unit 1204 has passed the acquisition privilege.

If YES in step S1506, the application message processing unit 1204 collectively acquires the remaining messages of the appropriate application in step S1508. Here, the application message processing unit 1204 may collectively acquire all the remaining messages of the appropriate application, or collectively acquire some of the remaining messages of the appropriate application.

In step S1509, the application message processing unit 1204 of the current application passes the acquisition privilege to the application message processing unit 1204 of the subsequent application. After passed the acquisition privilege, the application message processing unit 1204 of the current application rewrites the privilege gain status table in the same manner as in step S1506. Moreover, the application message processing unit 1204 of the current application memorizes that the application message processing unit 1204 of the current application has passed the acquisition privilege.

The algorithm ends after the above processing is performed.

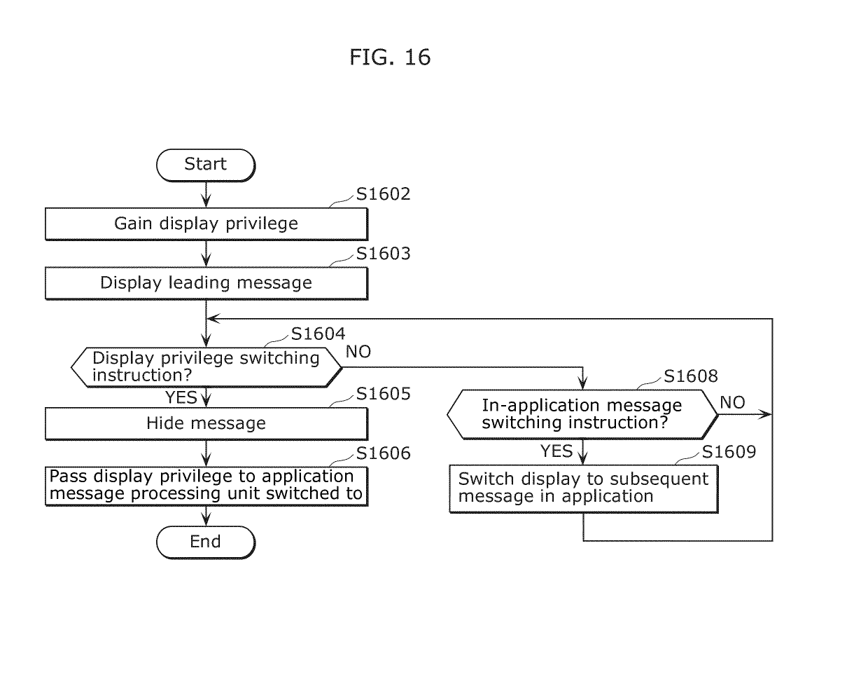

FIG. 16 is a flowchart illustrating an algorithm to switch the message display and the display privilege of the application message processing unit 1204 included in the data processing device 101.

In step S1602, the application message processing unit 1204 gains the display privilege to display messages from the application message control unit 1203 or another application message processing unit 1204. Once gained the display privilege, the application message processing unit 1204 starts the processing of the next step S1603.

In step S1603, the application message processing unit 1204 displays the leading message of the application.

In step S1604, the application message processing unit 1204 determines whether the application message processing unit 1204 has received the display privilege switching instruction from the application message control unit 1203.

If NO in step S1604, the application message processing unit 1204 determines in step S1608 whether the application message processing unit 1204 has received the in-application message switching instruction from the application message control unit 1203.

If NO in step S1608, the application message processing unit 1204 repeats step S1604, waiting again for the display privilege switching instruction or the in-application message switching instruction from the application message control unit 1203.

If YES in step S1608, the application message processing unit 1204 switches the display to the subsequent message in the application in step S1609, and repeats step S1604, waiting again for the display privilege switching instruction or the in-application message switching instruction from the application message control unit 1203.

If YES in step S1604, the application message processing unit 1204 hides the displayed message in step S1605.

In step S1606, the application message processing unit 1204 of the current application passes the display privilege to the application message processing unit 1204 switched to. After passed the display privilege, the application message processing unit 1204 of the current application rewrites “Current display privilege” in the privilege gain status table by the ID of the application switched to, and rewrites “Immediately preceding display privilege” by the ID of the own application.

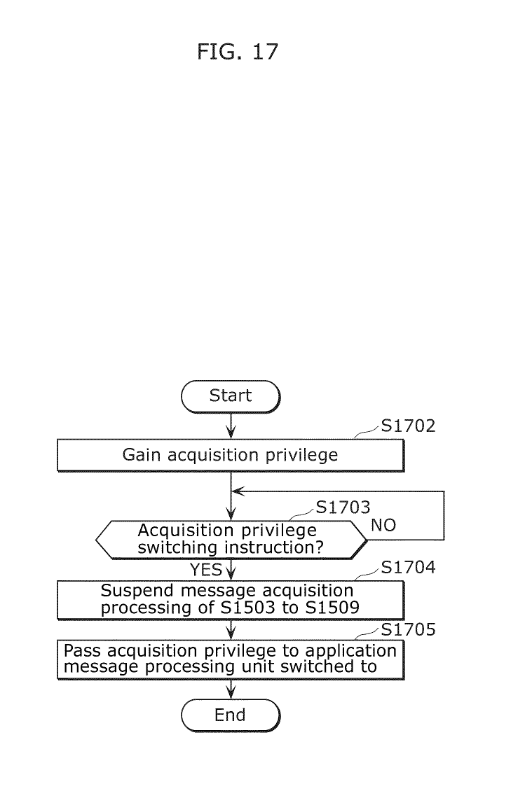

FIG. 17 is a flowchart illustrating an algorithm to switch the message acquisition privilege of the application message processing unit 1204 included in the data processing device 101.

In step S1702, the application message processing unit 1204 gains the acquisition privilege to acquire messages.

In step S1703, the application message processing unit 1204 determines whether the application message processing unit 1204 has received the acquisition privilege switching instruction from the application message control unit 1203.

If NO in step S1703, the application message processing unit 1204 repeats step S1703, waiting again for the acquisition privilege switching instruction from the application message control unit 1203.

If YES in step S1703, the application message processing unit 1204 suspends the acquisition of the message being acquired in step S1704.

In step S1705, the application message processing unit 1204 of the current application passes the acquisition privilege to the application message processing unit 1204 switched to. After passed the acquisition privilege, the application message processing unit 1204 of the current application rewrites “Current acquisition privilege” in the privilege gain status table by the ID of the application switched to, and rewrites “Immediately preceding acquisition privilege” by the ID of the own application.

The message suspended from being acquired is re-acquired when the application message processing unit 1204 has gained again the acquisition privilege. Therefore, the application message processing unit 1204 memorizes the message acquisition state.

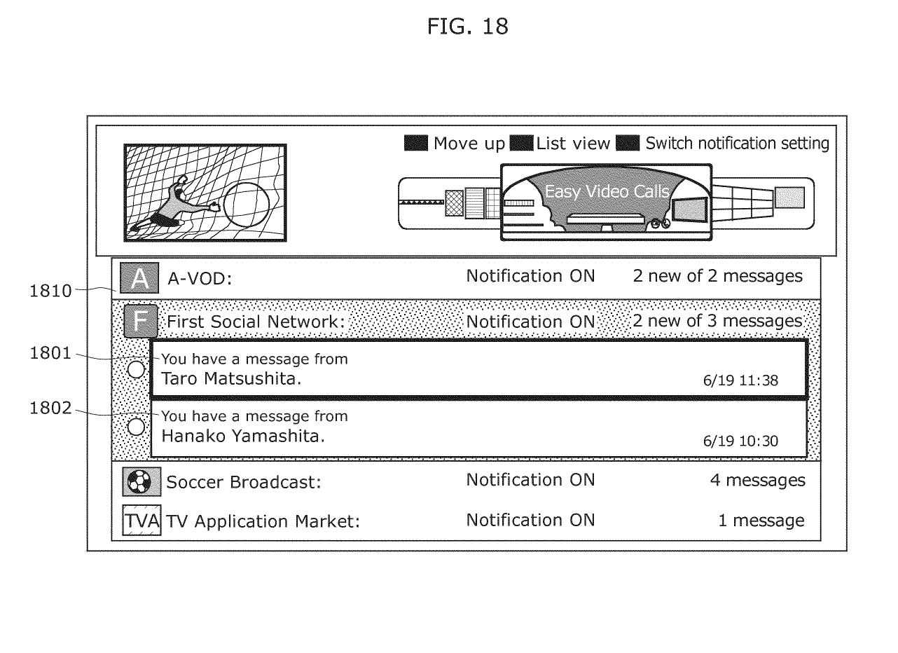

FIG. 18 is a diagram showing a fifth example of the message listing screen displayed by the data processing device.

FIG. 18 shows another example of the service provider switching by the remote controller operation. In the example, two messages (a message 1801 and a message 1802) are displayed by the service provider switching.

The operation of the data processing device 101 will be described with reference to the message listing screen shown in FIG. 3, FIG. 4, FIG. 5, FIG. 7, FIG. 8, FIG. 9, and FIG. 18, by way of example.

In FIG. 3, an application “A-VOD” is selected and the application's first message, ‘Drama “Paranormal” season 1 . . . ’ is displayed. When “down” key is depressed in this state, an application “First Social Network” is selected and the application's first message “You have a message from Taro Matsushita” is displayed as shown in FIG. 5. For any application, depressing “right” key displays the following message (FIG. 4).

In FIG. 8, the application “A-VOD” is selected and the application's first messages ‘Drama “Paranormal” season 1 . . . ’ and ‘Period drama “Hikaru Genji” part two . . . ’ are displayed. This is by way of example where two messages (leading messages) are initially displayed upon the selection of application, indicating that the number of leading messages is not limited to one. When “down” key is depressed twice in this state, an application “First Social Network” is selected and the application's first messages “You have a message from Taro Matsushita” and “You have a message from Hanako Yamashita” are displayed as shown in FIG. 18. For any application, depressing “right” key displays the following message (not shown).

According to the above processing, the data processing device 101 according to the present embodiment prefetches the messages for each application which are stored in the server in the order described below.

(1) The data processing device 101 displays the leading message (a first message) of the currently selected application (a first server). The currently selected application is, for example, in the examples of FIG. 3 and FIG. 7, the application 1 in FIG. 7 and A-VOD in FIG. 3, and is, in the examples of FIG. 8 and FIG. 9, the application 1 in FIG. 9 and A-VOD in FIG. 8. The leading message is, for example, in the examples of FIG. 3 and FIG. 7, a message 11 in FIG. 7 and ‘Drama “Paranormal” season 1 . . . ’ in FIG. 3, and is, in the examples of FIG. 8 and FIG. 9, the messages 11 and 12 in FIG. 9 and ‘Drama “Paranormal” season 1 . . . ’ and ‘Period drama “Hikaru Genji” part two . . . ’ in FIG. 8.

In the algorithm, for example, in the examples of FIG. 3 and FIG. 7, the acquisition privilege and the display privilege are passed to the application message processing unit 1204 of the application 1 shown in FIG. 7 in step S1303 of FIG. 13. Next, the data processing device 101 acquires the message 11 which is the leading message of the application 1 in steps S1502, S1503, and S1504 of FIG. 15. The leading message 11 of the application 1 is displayed in step S1603 of FIG. 16.

(2) The data processing device 101 prefetches the leading message (a second message) of an application (a second server) subsequent to the currently selected application. The currently selected application is, for example, in the examples of FIG. 3 and FIG. 7, the application 1 in FIG. 7 and A-VOD in FIG. 3, and is, in the examples of FIG. 8 and FIG. 9, the application 1 in FIG. 9 and A-VOD in FIG. 8. The application subsequent to the currently selected application is, for example, in the examples of FIG. 3 and FIG. 7, the application 2 in FIG. 7 and First Social Network in FIG. 3, and is, in the examples of FIG. 8 and FIG. 9, the application 2 in FIG. 9 and First Social Network in FIG. 8. The leading message is, for example, in the examples of FIG. 5 and FIG. 7, a message 21 in FIG. 7 and “You have a message from Taro Matsushita” in FIG. 5, and is, in the examples of FIG. 18 and FIG. 9, the messages 21 and 22 in FIG. 9 and “You have a message from Taro Matsushita” and “You have a message from Hanako Yamashita” in FIG. 18.

In the algorithm, the application message processing unit 1204 of the application 1 passes the acquisition privilege to the application message processing unit 1204 of the application 2, which is an application subsequent to the application 1, in step S1505 of FIG. 15, and the application message processing unit 1204 of the application 2 acquires the message 21 which is the leading message of the application 2 in steps S1502, S1503, and S1504 of FIG. 15.

(3) The data processing device 101 prefetches the following message (a third message) of the currently selected application. Here, the currently selected application is, for example, in the examples of FIG. 3 and FIG. 7, the application 1 in FIG. 7 and A-VOD in FIG. 3, and is, in the examples of FIG. 8 and FIG. 9, the application 1 in FIG. 9 and A-VOD in FIG. 8. The following message is, for example, in the example of FIG. 7, the messages 12 and 13 in FIG. 7, and is, in the example of FIG. 9, the message 13 in FIG. 9.

In the algorithm, the application message processing unit 1204 of the application 2 passes the acquisition privilege to the application message processing unit 1204 of the application 1, which is an application immediately preceding the application 2, in step S1505 of FIG. 15, and the application message processing unit 1204 of the application 1 acquires the remaining messages of the application 1 which are the messages 12 and 13 in steps S1502, S1503, S1506, and S1508 of FIG. 15, and passes the acquisition privilege to the application message processing unit 1204 of an application 3, which is next-next application to the application 1, in step S1509.

(4) The data processing device 101 prefetches the leading message of the next-next application to the currently selected application. Here, the currently selected application is, for example, in the examples of FIG. 3 and FIG. 7, the application 1 in FIG. 7 and A-VOD in FIG. 3, and is, in the examples of FIG. 8 and FIG. 9, the application 1 in FIG. 9 and A-VOD in FIG. 8. The next-next application is, for example, in the examples of FIG. 3 and FIG. 7, the application 3 in FIG. 7 and Soccer Broadcast in FIG. 3. The leading message is a message 31 in FIG. 7 in the example of FIG. 7.

In the algorithm, the application message processing unit 1204 of the application 3 acquires the message 31 which is the leading message of the application 3 in steps S1502, S1503, and S1504 in FIG. 15, and passes the acquisition privilege to the application message processing unit 1204 of the application 2, which is the application immediately preceding the application 3, in step S1505.

(5) The data processing device 101 prefetches the following message of the application subsequent to the currently selected application. Here, the currently selected application is, for example, in the examples of FIG. 3 and FIG. 7, the application 1 in FIG. 7 and A-VOD in FIG. 3, and is, in the examples of FIG. 8 and FIG. 9, the application 1 in FIG. 9 and A-VOD in FIG. 8. The subsequent application is, for example, in the examples of FIG. 3 and FIG. 7, the application 2 in FIG. 7 and First Social Network in FIG. 3, and is, in the examples of FIG. 8 and FIG. 9, the application 2 in FIG. 9 and First Social Network in FIG. 8. The following message is, for example, messages 22 and 23 in FIG. 7 in the examples of FIG. 3 and FIG. 7, and the message 23 in the example of FIG. 9.

In the algorithm, the application message processing unit 1204 of the application 2 acquires the messages 22 and 23 which are the remaining messages of the application 2 in steps S1502, S1503, S1506, and S1508 in FIG. 15. In the following, the application message processing unit 1204 of the application 2 passes the acquisition privilege to the application message processing unit 1204 of the application 3, which is the application subsequent to the application 2, in step S1509, and the same processing is performed with respect to the following applications.

In the above, the message of the application subsequent to the currently selected application is prefetched. However, a message of an application preceding the currently selected application may be prefetched by the same method as described above.

It should be noted that the order of the above processing (2) and (3) may be reversed. In other words, the first message may be acquired in (1), the third message may be thereafter acquired in (3), and then the second message may be acquired in (2). This also can achieve the same advantageous effects as the above.

Furthermore, the above processing (2) and (3) may be performed simultaneously (or sequentially at as sufficiently short interval as can be regarded simultaneous). In other words, the first message may be acquired in (1), and then the third message may be acquired in (3) and at the same time the second message is acquired in (2). This also can achieve the same advantageous effects as described above.

The data processing device 101 according to the present embodiment acquires, in advance, only the leading message without collectively acquiring all the messages of the application, thereby allowing for the acquired leading message to be displayed even when the application switching instruction is given. This accelerates the message display. Thus, the user convenience can be enhanced.

Components essential to the present disclosure will be described, with reference to FIG. 20.

FIG. 20 is a functional block diagram of a third example of the primary functional block configuration of the data processing device (a data processing device 101B).

As shown in FIG. 20, the data processing device 1018 includes a selection unit 2001, an acquisition unit 2002, and a display unit 2003.

The selection unit 2001 selects a server from among a plurality of servers.

The acquisition unit 2002 acquires messages from the plurality of servers. Moreover, the acquisition unit 2002 acquires some messages from the server, and, before acquiring the remaining messages from the server, acquires some messages from a server which is next likely to be selected by the selection unit 2001 after the server.

The display unit 2003 displays the message acquired by the acquisition unit 2002 from the server selected by the selection unit 2001.

[1-3. Effects]

As described above, according to the data processing device of the present embodiment, a message which is next likely to be read by the user can be acquired (prefetched) before the user performs the operation in a state where the data processing device is displaying a message. When the user thereafter selects a message desired by the user to read next, the message desired by the user to read next is already acquired by the prefetch into the data processing device. Thus, when the user selects the message desired by the user to read next, the data processing device can immediately display the message. Thus, the latency of the message display can be reduced.

Moreover, according to the display order on the display unit, a message which is likely to be read next by the user can be acquired (prefetched) before the user performs the operation. Thus, the latency of the message display can be reduced.

In particular, the data processing device according to the present embodiment has a great effect for a device (for example, a TV operated by a remote controller having up, down, left, and right keys) which has an interface through which the message selection state transitions by user operation from the message currently being read to a message desired by the user to read next, thereby selecting the message desired by the user to read next.

Moreover, a message which is next likely to be read by the user can be acquired (prefetched) before the user performs the operation in a state where the first message of the first server is in the selected state. The message which is next likely to be read by the user is, specifically, one (the second message) of the messages from the second server, and messages (the third message(s)) from the first server other than the first message. When the user thereafter selects a message desired by the user to read next, the message desired by the user to read next is already acquired by the prefetch into the data processing device. Thus, when the user selects the message desired by the user to read next, the data processing device can immediately display the message. Thus, the latency of the message display can be reduced.

Moreover, a message which is unread by the user is acquired as the first message. The user can efficiently read the unread message.

Moreover, a message stored in the first server other than the first message is acquired as the third message(s). This acquires all the messages in the first server into the data processing device. The latency of the message display can be reduced, in particular, when the user wishes to read messages in the first server one after another.

Moreover, a message is acquired in the same manner also from a third server from which the user is next likely to read messages after the second server. The latency of the message display can be reduced, in particular, when the user wishes to read messages from different servers one after another.

Moreover, a message is acquired in the same manner also from a fourth server from which the user is next likely to read messages as well as the second server. The latency of the message display can be reduced, in particular, when the user wishes to check a previous message again while reading messages from different servers one after another.

Moreover, a message acquired from a server can be held in the data processing device. If a new message is held and exceeds the storage capacity within the data processing device, a message is deleted starting with a message displayed most distant from a server or a message (the message being read by the user) that is selected on the display unit. The message displayed more distant from where the cursor is displayed on the display unit is relatively less likely to be read next by the user. Thus, by doing this, the latency of the message display can be reduced.

Moreover, the user can visually understand the selected server or the selected message by the cursor displayed on the display unit.

<Supplementary>

Above, the data processing device according to the present embodiment has been described. However, the following variation is possible and the present disclosure is, of course, not limited to the data processing device as described with reference to the above embodiment.

(1) In the embodiment, the messages may be switched by a slide operation by a finger rather than the remote controller.

(2) In the embodiment, the example has been given in which there is one or two leading messages which are messages initially displayed when the application is switched. However, the number of leading messages is not limited to one or two, and may be more.

(3) In the embodiment, the application message processing unit 1204 of each application initially acquires the same number of messages as the leading messages. However, the application message processing unit 1204 of each application may initially acquire at least the same number of messages as the leading messages, and may acquire more messages than the number of leading messages.

In that case, some of the following messages can be promptly displayed even when “right” key for displaying the following message is depressed rather than “down” key for switching applications. It should be noted that only the application message processing unit 1204 of an application the user frequently refers to messages thereof may initially acquire more messages than the number of leading messages.

It should be noted that while the present disclosure can be described as below, the present disclosure is not limited thereto.

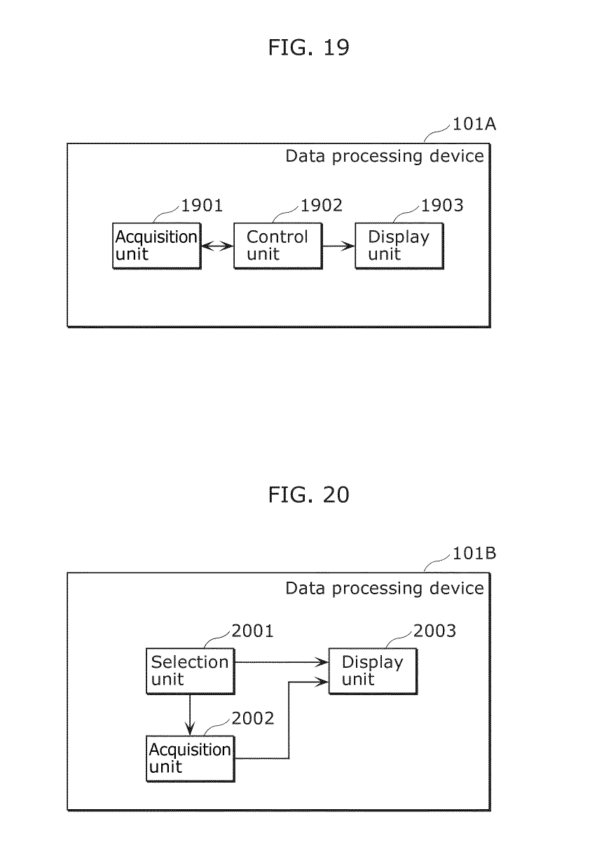

The present disclosure is a data processing device 101A which displays messages included in plural servers, according to instructions by a user, the data processing device 101A including: an acquisition unit 1901 which acquires messages from the plural servers; a display unit 1903 which arranges and displays pieces of information indicative of the plural servers; and a control unit 1902 which, according to the instructions from the user, sets an area corresponding to a first server which is one of the plural servers to a selected state on the display unit 1903 and displays a first message acquired from the first server by the acquisition unit 1901 on the area set to the selected state, wherein the acquisition unit 1901 acquires a second message from a second server which is one of the plural servers and subsequent to the first server on the arrangement order on the display unit 1903, and acquires, from the first server, at least one third message different from the first message, in a period in which the control unit 1902 displays the first message on the display unit 1903 (FIG. 19).

According to the data processing device 101A described above, a message which is next likely to be read by the user can be acquired (prefetched) before the user performs the operation in a state where the first message of the first server is in the selected state. The message which is next likely to be read by the user is, specifically, one (the second message) of the messages from the second server, and a message (the third message(s)) from the first server other than the first message. When the user thereafter selects a message desired by the user to read next, the message desired by the user to read next is already acquired by the prefetch into the data processing device. Thus, when the user selects the message desired by the user to read next, the data processing device can immediately display the message. Thus, the latency of the message display can be reduced.

In particular, the data processing device according to the present embodiment has a great effect for a device (for example, a TV operated by a remote controller having up, down, left, and right keys) which has an interface through which the message selection state transitions by user operation from the message currently being read to a message desired by the user to read next, thereby selecting the message desired by the user to read next.

As the above, the embodiment has been described by way of example of the technology of the present disclosure. To this extent, the accompanying drawings and detailed description are provided.

Thus, the components set forth in the accompanying drawings and detailed description includes not only components essential to solve the problems but also components unnecessary to solve the problems for illustrating the above embodiments. Thus, those unnecessary components should not be acknowledged essential due to the mere fact that the unnecessary components are described in the accompanying drawings and the detailed description.

The above embodiment illustrates the technology of the present disclosure, and thus various modifications, permutations, additions and omissions are possible in the scope of the appended claims and the equivalents thereof.

Although only some exemplary embodiments of the present invention have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The data processing device according to the present disclosure is widely applicable to devices having data reception functionality and read functionality.

1. A data processing device comprising:
a selection unit configured to select a server from among plural servers;
an acquisition unit configured to acquire messages from the plural servers; and
a display unit configured to display one or more messages acquired by the acquisition unit from the server selected by the selection unit,
wherein the acquisition unit is configured to acquire a message from the server and, before acquiring a remaining message from the server, acquire a message from a server which is next likely to be selected by the selection unit after the server.

2. The data processing device according to claim 1,
wherein the display unit is configured to display pieces of information indicating the plural servers which have included the messages acquired by the acquisition unit, the pieces of information being arranged, and
the acquisition unit is configured to acquire, before acquiring the remaining message from the server, a message from a server, among the plural servers, that is subsequent to the server in arrangement order on the display unit.

3. The data processing device according to claim 2,
wherein the selection unit is configured to select a first server, which is the server selected by the selection unit, according an instruction from a user,
the acquisition unit is configured to acquire at least one first message which is the one or more messages from the first server, and
the acquisition unit is further configured to acquire a second message which is a message from a second server which is one of the plural servers and subsequent to the first server in the arrangement order on the display unit, and acquire, as a remaining message, at least one third message different from the at least one first message from the first server, in a period in which the display unit displays the at least one first message.

4. The data processing device according to claim 3,
wherein the acquisition unit is configured to acquire, as the at least one first message, a new message which has not been acquired by the acquisition unit among messages included in the first server.

5. The data processing device according to claim 3,
wherein the acquisition unit is configured to acquire, as the at least one third message, a remaining message included in the first server except for the at least one first message.

6. The data processing device according to claim 3,
wherein after acquiring the at least one third message, the acquisition unit is configured to acquire a fourth message from a third server which is one of the plural servers and subsequent to the second server in the arrangement order on the display unit, and acquire at least one message different from the second message from the second server.

7. The data processing device according to claim 3,
wherein after acquiring the at least one third message, the acquisition unit is configured to acquire a message from a fourth server which is one of the plural servers and preceding the first server in the arrangement order on the display unit.

8. The data processing device according to claim 3, further comprising:
a holding unit including a memory and configured to hold the messages acquired by the acquisition unit,
wherein when the acquisition unit acquires a new message, the holding unit is configured to
store the new message in the memory, and
preferentially delete, from the memory, a message, among the messages displayed on the display unit, that is displayed at a position most distant from a position at which information, among the pieces of information, which indicates the server selected by the selection unit is displayed.

9. The data processing device according to claim 3,
wherein the display unit is further configured to display a cursor at a position where information, among the pieces of information, is displayed which indicates the server selected by the selection unit.

10. A data processing method comprising:
(a) selecting a server from among plural servers;
(b) acquiring messages from the plural servers; and
(c) displaying one or more messages acquired in step (b) from the server selected in step (a),
wherein in step (b), a message is acquired from the server and, before acquiring a remaining message from the server, a message is acquired from a server which is next likely to be selected in step (a) after the server.

11. A non-transitory computer-readable storage medium having stored therein a computer program for causing a computer to execute the data processing method according to claim 10.
